(19) United States
(12) Patent Application Publication
(10) Pub. No.: US 2018/0041063 A1
(43) Pub. Date: Feb. 8, 2018

(54) CHARGING METHOD AND CHARGING SYSTEM FOR NICKEL-HYDROGEN BATTERY

(71) Applicant: TOYOTA JIDOSHA KABUSHIKI KAISHA, Toyota-shi (JP)

(72) Inventor: Keisuke ISOMURA, Kariya-shi (JP)

(73) Assignee: TOYOTA JIDOSHA KABUSHIKI KAISHA, Toyota-shi (JP)

(21) Appl. No.: 15/669,130

(22) Filed: Aug. 4, 2017

(30) Foreign Application Priority Data
Aug. 8, 2016 (JP) 2016-155782

(51) Int. Cl. H02J 7/00; H01M 10/48; H01M 10/44

(52) U.S. Cl. CPC H02J 7/0072; H01M 10/44; H01M 10/48; B60L 11/1809

(57) ABSTRACT

A charging method according to the present invention is a charging method for a nickel-hydrogen battery provided with a positive electrode at least including nickel hydroxide. The feature of this charging method is that the nickel-hydrogen battery is charged by supplying only a square-wave pulse current having a repetition frequency that is set within a range from 5 kHz to 10 kHz and having an average current value that is set within a range from 1 A to 10 A.

### CROSS-REFERENCE

The present application claims priority on the basis of Japanese Patent Application No. 2016-155782 filed in Japan on Aug. 8, 2016, the entire contents of which are incorporated herein by reference.

### BACKGROUND OF THE INVENTION

### 1. Field of the Invention

The present invention relates to a charging method and a charging system for a nickel-hydrogen battery provided with a positive electrode including nickel hydroxide.

### 2. Description of the Related Art

As witnessed in, for example, the recent proliferation of mobile devices, the increasing popularity of hybrid vehicles against the background of environmental and energy issues, and the development of electrical vehicles and large stationary batteries for storing surplus power, the role played by batteries and, particularly, secondary batteries, and expectations therefor are ever increasing. In particular, nickel-hydrogen batteries which are a type of secondary batteries use a nonflammable aqueous electrolyte and, even when relatively rapidly charged by a constant current, charging is automatically replaced by electrolysis of water contained in the electrolyte when fully charged to suppress further voltage rise. Accordingly, the importance of nickel-hydrogen batteries is increasing as batteries which are relatively safe and which enable charging to be readily controlled. Japanese Patent No. 4749095 is an example of technical literature related to a regeneration method for a nickel-hydrogen battery.

A nickel-hydrogen battery uses nickel hydroxide in a positive electrode, a hydrogen storage alloy in a negative electrode, and an alkaline electrolyte as an electrolyte. At the negative electrode, as shown in equations (1) and (2) below, electrochemical reduction of hydrogen in water molecules and occlusion of hydrogen to the hydrogen storage alloy occur during charge and, conversely, electrochemical oxidation of stored hydrogen occurs during discharge.

[Charge]H₂0+e⁻→H (occlusion)+OH⁻ (1)

[Discharge]H (occlusion)+OH⁻H₂0+e⁻ (2)

As the hydrogen storage alloy, an alloy based on rare earth and nickel is mainly used.

At the positive electrode, as shown in equations (3) and (4) below, an electrochemical redox reaction of nickel hydroxide and nickel oxyhydroxide occurs.

[Charge]Ni(OH)₂+OH⁻NiOOH+H₂O+e⁻ (3)

[Discharge]NiOOH+H₂O+e⁻→Ni(OH)₂+OH⁻ (4)

### SUMMARY OF THE INVENTION

This type of nickel-hydrogen battery is charged by a constant current value from an external power supply to store energy in the battery. In addition, the nickel-hydrogen battery is discharged by a constant current value from the battery to supply energy to a load. According to findings by the present inventors, a crystalline structure of nickel hydroxide included in a positive electrode may collapse and become deactivated due to repetitively performing such charge and discharge. When nickel hydroxide is deactivated, the electrode becomes inactive and the electrochemical redox reaction described above is less likely to occur. As a result, discharge capacity (chargeable and dischargeable capacity) may decline. A technique is desired which enables a nickel-hydrogen battery to be charged and discharged while suppressing a decline in discharge capacity due to deactivation of nickel hydroxide.

The present invention has been made in consideration of the circumstances described above and a main object thereof is to provide a charging method for a nickel-hydrogen battery which enables the nickel-hydrogen battery to be charged and discharged while suppressing a decline in discharge capacity. Another object of the present invention is to provide a system capable of preferably implementing the charging method.

In order to realize the object described above, the present invention provides a charging method for a nickel-hydrogen battery provided with a positive electrode at least including nickel hydroxide. The charging method for a nickel-hydrogen battery involves charging the nickel-hydrogen battery by supplying only a square-wave pulse current having a repetition frequency that is set within a range from 5 kHz to 10 kHz and having an average current value that is set within a range from 1 A to 10 A. According to this charging method, a nickel-hydrogen battery can be charged while suppressing a decline in discharge capacity (chargeable and dischargeable capacity). As a result, prolongation of the life of the nickel-hydrogen battery can be achieved.

In addition, in order to realize the object described above, the present invention provides a system which charges a nickel-hydrogen battery provided with a positive electrode at least including nickel hydroxide.

The charging system includes: a charging device which supplies a direct current to the nickel-hydrogen battery; a switching device which is connected between the nickel-hydrogen battery and the charging device; and a control device which controls the switching device so that the direct current supplied to the nickel-hydrogen battery from the charging device is converted into a square-wave pulse current having a repetition frequency that is set within a range from 5 kHz to 10 kHz and having an average current value that is set within a range from 1 A to 10 A. According to the charging system described above, with a simple configuration of incorporating a switching device between a nickel-hydrogen battery and a charging device, it is possible to appropriately supply a square-wave pulse current having a repetition frequency that is set within a range from 5 kHz to 10 kHz and having an average current value that is set within a range from 1 A to 10 A. Therefore, such a system can be preferably adopted as a system for implementing the charging method described above.

### BRIEF DESCRIPTION OF THE DRAWINGS

FIG. 1 is a partially-broken perspective view schematically showing an embodiment of a nickel-hydrogen battery;

FIG. 2 is a graph showing an X-ray diffraction pattern before degradation;

FIG. 3 is a graph showing an X-ray diffraction pattern after degradation;

FIG. 4 is a graph showing an X-ray diffraction pattern after a pulse charging process;

FIG. 5 is graph showing a waveform of a pulse current;

FIG. 6 is a diagram showing a schematic configuration of a charging system according to an embodiment; and

FIG. 7 is graph showing a transition of a discharge amount.

### DETAILED DESCRIPTION OF THE INVENTION

Hereinafter, an embodiment according to the present invention will be described with reference to the drawings. In the following drawings, members and portions that produce the same effects will be described using the same reference characters. It should be noted that dimensional relationships (length, width, thickness, and the like) shown in the respective drawings do not reflect actual dimensional relationships. In addition, any matters not specifically mentioned in the present specification but necessary for the implementation of the present invention (for example, a configuration and a method of producing an electrode body including a positive electrode and a negative electrode, a configuration and a method of producing a separator or an electrolyte, general techniques related to the construction of a nickel-hydrogen battery and other batteries, and the like) can be construed as design items for a person skilled in the art on the basis of prior art in the relevant field.

Moreover, in the present specification, a “pulse current” refers to a square-wave (rectangular wave) direct current in which ON and OFF (zero) are alternately repeated and an “average current value” refers to a current value per unit time of a square-wave pulse current. In addition, an “SOC” refers to a depth of charge (state of charge) and indicates a state of charge in a range of operating voltage capable of reversible charge and discharge when a state of charge at which an upper limit voltage is obtained (in other words, a fully charged state) is assumed to be 100% and a state of charge at which a lower limit voltage is obtained (in other words, an uncharged state) is assumed to be 0%. For example, an SOC can be acquired from inter-terminal voltage of a battery. Furthermore, a “discharge capacity” refers to a capacity which can be reversibly charged and discharged within an SOC range of 0% to 100%.

Hereinafter, a charging method and a charging system for a nickel-hydrogen battery according to an embodiment of the present invention will be described in an order of a configuration of a nickel-hydrogen battery that is an object, a charging method, and a charging system.

### <Nickel-hydrogen Battery>

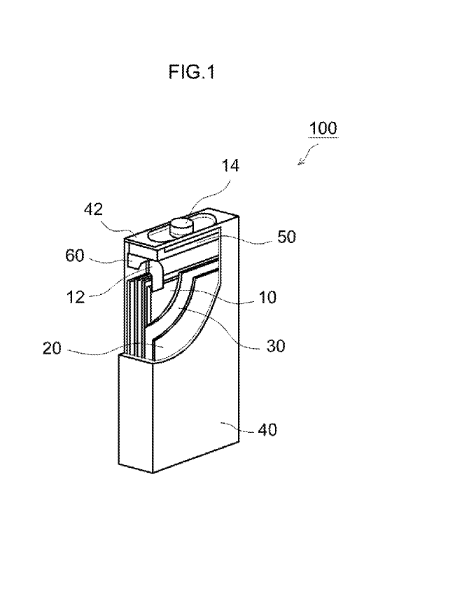

A nickel-hydrogen battery 100 (hereinafter, referred to as a “battery” when appropriate) that is an object of the charging method according to the present embodiment is provided with, for example, a case 40 including a lid 42 as shown in FIG. 1. The case 40 houses therein a positive electrode 10, a negative electrode 20, and a separator 30 which constitute an electrode body of the nickel-hydrogen battery 100 according to the present embodiment.

The positive electrode 10 is constituted by a plurality of thin plate-shaped (sheet-shaped) electrode structures which are electrically connected to a positive electrode terminal 14 via a positive electrode collector tab 12. Meanwhile, the negative electrode 20 is constituted by a plurality of thin plate-shaped (sheet-shaped) electrode structures which are connected to a negative electrode terminal (not shown) provided on a bottom surface of the case 40 via a negative electrode collector member (not shown). In addition, a spacer 60 and a gasket 50 provided in a periphery thereof are mounted to the case 40 on the inner side of the lid 42 to keep the interior of the case 40 in a sealed state.

Moreover, while a gas release vent structure for releasing internal gas to the outside of the case when gas pressure inside the battery 100 (inside the case 40) abnormally rises is formed on the spacer 60, since a structure similar to those attached to conventional nickel-hydrogen batteries may suffice and the structure does not characterize the present invention, a further detailed description thereof will be omitted.

The positive electrode 10 includes a positive electrode current collector and a positive electrode active material layer formed on both surfaces of the positive electrode current collector. The positive electrode current collector has a foil shape. The positive electrode current collector is preferably a nickel foil. The positive electrode active material layer includes nickel hydroxide as a positive electrode active material. Nickel hydroxide is converted into nickel oxyhydroxide in a battery reaction during charge. In addition, nickel oxyhydroxide is converted into nickel hydroxide in a battery reaction during discharge. The nickel hydroxide may be hydrated. Furthermore, for the purpose of improving characteristics of the positive electrode active material and the like, a part of the nickel element of nickel hydroxide may be replaced by another metallic element (for example, cobalt, aluminum, zinc, manganese, tungsten, titanium, niobium, ruthenium, and gold).

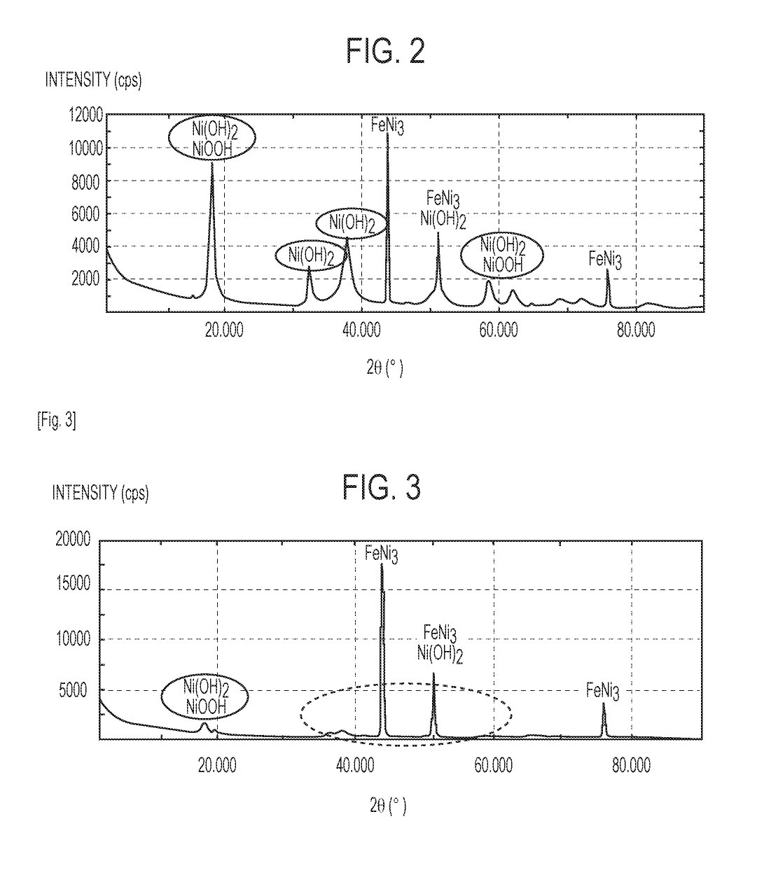

The nickel hydroxide is typically crystalline nickel hydroxide. The nickel hydroxide being crystalline can be confirmed by an X-ray diffraction pattern obtained by an X-ray powder diffraction method using CuKa rays. In other words, as shown in FIG. 2, when a peak belonging to nickel hydroxide is observed in the X-ray diffraction pattern, the nickel hydroxide may be considered crystalline.

The negative electrode 20 includes a negative electrode current collector and a negative electrode active material layer formed on both surfaces of the negative electrode current collector. The negative electrode current collector has a foil shape. The negative electrode current collector is preferably a nickel foil. The negative electrode active material layer includes a negative electrode active material. The negative electrode active material can be iron hydroxide, zinc oxide, or a hydrogen storage alloy. As the hydrogen storage alloy, a known alloy used as a negative electrode active material of a nickel hydrogen secondary battery can be used and examples thereof include an alloy including rare earth and nickel. The negative electrode active material may be hydrated. In addition, for the purpose of improving characteristics of the negative electrode active material and the like, a part of the iron element of iron hydroxide may be replaced by another metallic element (for example, cobalt, tungsten, titanium, niobium, ruthenium, and gold) and a part of the zinc element of zinc oxide may be replaced by another metallic element (for example, cobalt, tungsten, titanium, niobium, ruthenium, and gold).

As the separator 30, a separator used in conventional nickel-hydrogen batteries can be used. For example, a hydrophilized resin material (for example, a sulfonated nonwoven polypropylene fabric) can be used as the separator 30.

In the nickel-hydrogen battery 100, an electrode body including the positive electrode 10, the negative electrode 20, and the separator 30 described above is housed inside the case 40 from an opening of the case 40, and an appropriate electrolyte is arranged (injected) in the case 40. As the electrolyte, an alkaline water-based solution including potassium hydroxide or the like can be used.

Subsequently, the opening of the case 40 is sealed to complete assembly of the nickel-hydrogen battery 100. A sealing process of the case 40 and an arrangement (injection) process of the electrolyte can be performed in a similar manner to methods used when manufacturing a conventional nickel-hydrogen battery and do not characterize the present invention. Construction of the nickel-hydrogen battery 100 is completed in this manner.

This type of nickel-hydrogen battery is charged by a constant current value from an external power supply to store energy in the battery. In addition, the nickel-hydrogen battery is discharged by a constant current value from the battery to supply energy to a load. According to findings by the present inventors, a crystalline structure of nickel hydroxide and nickel oxyhydroxide included in the positive electrode may collapse and become deactivated (typically, become inactive-crystallized including an amorphous state) due to repetitively performing such charge and discharge. Deactivation of nickel hydroxide and nickel oxyhydroxide can be confirmed by, for example, as shown in FIG. 3, peaks belonging to nickel hydroxide and nickel oxyhydroxide not observed or observed to decrease in peak intensity in an X-ray diffraction pattern obtained by an X-ray powder diffraction method using CuKa rays. When nickel hydroxide and nickel oxyhydroxide are deactivated in this manner, the electrode also becomes inactive and electrochemical redox reactions are less likely to occur. As a result, discharge capacity may decline.

Through various experiments, the present inventors have found that charge using a pulse current with a specific waveform may promote reactivation (typically, active recrystallization) of deactivated nickel hydroxide and nickel oxyhydroxide and may enable degraded discharge capacity to be recovered. Specifically, a cycle degradation test was performed by preparing, in plurality, a nickel-hydrogen battery (a test cell including nickel hydroxide powder as a positive electrode active material) having a prescribed initial capacity (rated capacity) and, on each cell, repeating charge-discharge cycles until discharge capacity degraded to 50% or lower of the initial capacity (capacity when new). In addition, after discharging each cell following the cycle degradation test until the SOC dropped to 0%, a pulse charging process was performed by supplying a square-wave pulse current having a repetition frequency, an average current value, and a duty ratio that are set to values shown in Table 1 to charge the cell until the SOC reached 100%. In this case, 10 cells were submitted for each of the Examples 1 to 8 to perform the pulse charging process. In addition, the discharge capacity after the pulse charging process was measured. Results thereof are shown in Table 1. In this case, the discharge capacity after the pulse charging process represents an average value of the discharge capacities of the 10 cells submitted in each example and is indicated by a relative value when the initial capacity is assumed to be 100%.

TABLE 1

| | | | | | Average value of |
|---|---|---|---|---|---|
| | Pulse current conditions | | | | discharge capacities |
| | Average | | | Number of | (of 10 cells) |
| | value of | Repetition | Duty | times | after pulse charging |
| | current | frequency | ratio | processed | process |
| | (A) | (kHz) | (%) | (times) | (%) |
| Example 1 | 1 | 10 | 50 | 1 | 65.3 |
| Example 2 | 3 | 10 | 50 | 1 | 78.9 |
| Example 3 | 10 | 10 | 50 | 1 | 60.1 |
| Example 4 | 20 | 10 | 50 | 1 | 51.2 |
| Example 5 | 3 | 5 | 50 | 1 | 78.4 |
| Example 6 | 3 | 10 | 20 | 1 | 71.7 |
| Example 7 | 3 | 10 | 30 | 1 | 72 |
| Example 8 | 3 | 10 | 60 | 1 | 70.8 |

As shown in Table 1, in Examples 1 to 3 and 5 to 8 on which pulse charging processes were performed under conditions in which the repetition frequency of the pulse current was 5 kHz to 10 kHz and the average value of the pulse current was 1 A to 10 A, the discharge capacity after the pulse charging process recovered to 60% of the initial capacity or more. This result shows that, by performing a pulse charging process of charging by supplying a square-wave pulse current having a repetition frequency that is set within a range from 5 kHz to 10 kHz and having an average current value that is set within a range from 1 A to 10 A, the degraded discharge capacity of a nickel-hydrogen battery can be recovered.

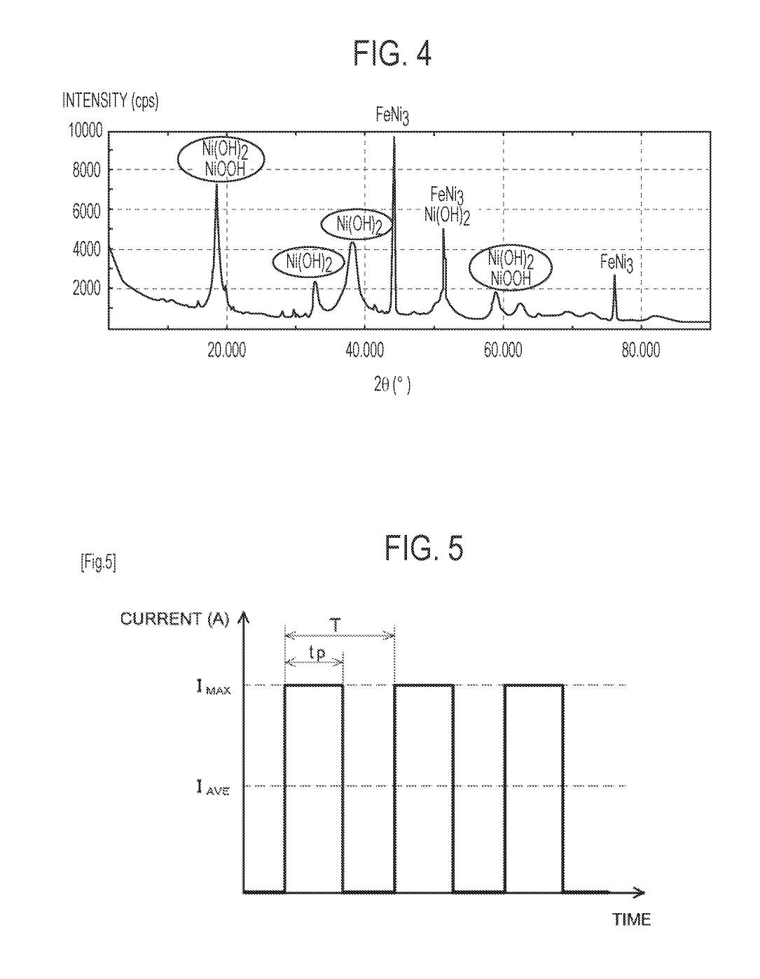

In addition, the cells used in Example 2 were disassembled before and after the cycle degradation test and after the pulse charging process and the positive electrode active material was collected. Subsequently, an X-ray diffraction pattern of the collected positive electrode active material was measured. Results thereof are shown in FIGS. 2 to 4. FIG. 2 is a graph showing an X-ray diffraction pattern before the cycle degradation test, FIG. 3 is a graph showing an X-ray diffraction pattern after the cycle degradation test, and FIG. 4 is a graph showing an X-ray diffraction pattern after the pulse charging process.

As shown in FIG. 2, in the X-ray diffraction pattern before the cycle degradation test, peaks belonging to nickel hydroxide and nickel oxyhydroxide were observed to confirm that the nickel hydroxide and the nickel oxyhydroxide were crystalline. On the other hand, in the X-ray diffraction pattern after the cycle degradation test shown in FIG. 3, it was confirmed that peaks belonging to nickel hydroxide and nickel oxyhydroxide have almost entirely disappeared or intensity of the peaks has declined and that the nickel hydroxide and the nickel oxyhydroxide have been deactivated. By comparison, in the X-ray diffraction pattern after the cycle degradation test shown in FIG. 4, it was confirmed that peaks belonging to nickel hydroxide and nickel oxyhydroxide were once again observed and that the nickel hydroxide and the nickel oxyhydroxide have been reactivated.

From these results, it was confirmed that, due to the pulse charging process using a pulse current having a specific waveform, reactivation of deactivated nickel hydroxide and nickel oxyhydroxide is promoted and degraded discharge capacity can be recovered. In other words, by constant charge using a pulse current having a specific waveform, reactivation of nickel hydroxide and the like can be promoted (degraded discharge capacity can be recovered) while charging a nickel-hydrogen battery and a decline in discharge capacity can be suppressed.

Based on the findings described above, the charging method for a nickel-hydrogen battery according to the present embodiment characteristically involves, as shown in FIG. 5, charging a nickel-hydrogen battery provided with a positive electrode at least including nickel hydroxide by supplying the nickel-hydrogen battery with only a square-wave pulse current having a repetition frequency that is set within a range from 5 kHz to 10 kHz and having an average current value that is set within a range from 1 A to 10 A. According to this charging method, a nickel-hydrogen battery can be charged while suppressing a decline in discharge capacity attributable to deactivation of nickel hydroxide. As a result, prolongation of the life of the nickel-hydrogen battery can be achieved.

An average value of a pulse current (hereinafter, also simply described as “I_{AVE}”) in the pulse charging process described above is appropriately set to approximately 10 A or lower (in other words, I_{AVE}≦10 A). When the average value of the pulse current I_{AVE} is too high, heat generated by a load due to the pulse charge raises battery temperature and causes energy loss. As a result, reactivation of nickel hydroxide and the like may not proceed sufficiently and a decline in discharge capacity cannot be suppressed. From the perspective of suppressing a decline in discharge capacity, the average value of the pulse current I_{AVE} is favorably I_{AVE}≦8 A, more favorably I_{AVE}≦5 A, and even more favorably I_{AVE}≦3.6 A. In addition, the average value of the pulse current I_{AVE} can normally be 1 A or higher (in other words, 1 A≦I_{AVE}). When the average value of the pulse current I_{AVE} is within this range, reactivation of deactivated nickel hydroxide and the like can be reliably promoted. Furthermore, since quick charge becomes possible, a charging process can be performed in a short period of time. From the perspectives of quick charge and the like, the average value of the pulse current is favorably 1.2 A≦I_{AVE}, more favorably 1.5 A≦I_{AVE}, and even more favorably 1.8 A≦I_{AVE}. The technique disclosed herein can be favorably implemented in an aspect in which the average value of the pulse current I_{AVE} is, for example, 1 A or higher and 10 A or lower (typically, 1 A or higher and 3.6 A or lower).

The repetition frequency of the pulse current (hereinafter, also simply described as “f”) described earlier is expressed as f=1/T, where T denotes a repetition period of a pulse waveform. The repetition frequency can normally be 5 kHz or higher and 10 kHz or lower (5 kHz≦f≦10 kHz). By setting the repetition frequency of the pulse current to 5 kHz or higher and 10 kHz or lower, reactivation of deactivated nickel hydroxide can be sufficiently promoted and a decline in discharge capacity can be suppressed. The repetition frequency may be, for example, 6 kHz≦f and, typically, 7 kHz≦f. In addition, the repetition frequency may be, for example, f≦9 kHz and, typically, f≦8 kHz.

An amplitude of the pulse current (hereinafter, also simply described as “I_{MAX}”) is not particularly limited as long as the average value of the pulse current (I_{AVE}) and the repetition frequency (f) satisfy the numerical ranges provided above. Normally, the amplitude of the pulse current is appropriately set to 2 A or higher and, from the perspectives of quick charge (charging efficiency) and the like, the amplitude of the pulse current is favorably 3 A≦I_{MAX}, more favorably 4 A≦I_{MAX}, and even more favorably 5 A≦I_{MAX}. In addition, while an upper limit of the amplitude of the pulse current is not particular limited, for example, the amplitude of the pulse current is 20 A or lower and, from the perspectives of reliably suppressing a decline in discharge capacity and the like, the amplitude of the pulse current is favorably I_{MAX} ≦16 A, more favorably I_{MAX}≦10 A, and even more favorably I_{MAX}≦7.2 A. The technique disclosed herein can be favorably implemented in an aspect in which the amplitude of the pulse current described above is, for example, 2 A or higher and 20 A or lower (typically, 2 A or higher and 7.2 A or lower).

A pulse width of the pulse current (hereinafter, also simply described as “tp”) is not particularly limited as long as the average value of the pulse current (I_{AVE}) and the repetition frequency (f) satisfy the numerical ranges provided above. For example, the pulse width of the pulse current is appropriately set to 1.6×10⁻⁴ seconds or less and, from the perspectives of suppressing a decline in discharge capacity and the like, the pulse width of the pulse current is favorably 1.2×10⁻⁴ seconds or less. For example, the pulse width of the pulse current may be tp≦1×10⁻⁴ seconds and, typically, tp≦8×10⁻⁵ seconds. In addition, while a lower limit of the pulse width of the pulse current is not particularly limited, for example, the pulse width of the pulse current can be 2×10⁻⁵ seconds or more. From the perspectives of quick charge and the like, the pulse width is favorably 4×10⁻⁵ seconds tp and more favorably 5×10⁻⁵ seconds≦tp. The technique disclosed herein can be favorably implemented in an aspect in which the pulse width of the pulse current is, for example, 2×10⁻⁵ seconds or more and 1.6×10⁻⁴ seconds or less (typically, 5×10⁻⁵ seconds or more and 1×10⁻⁴ seconds or less).

A duty ratio of the pulse current (hereinafter, also simply described as “D”) is represented by a ratio between the pulse width tp and the repetition period T (tp/T). The duty ratio is not particularly limited as long as the average value of the pulse current (I_{AVE}) and the repetition frequency (f) satisfy the numerical ranges provided above. The duty ratio of the pulse current can be, for example, 80% or lower (in other words, D≦80%). From the perspectives of suppressing a decline in discharge capacity and the like, the duty ratio of the pulse current is favorably D≦70% and more favorably D≦60%. In addition, the duty ratio of the pulse current can be, for example, 20% or higher (in other words, 20%≦D). From the perspectives of quick charge and the like, the duty ratio is favorably 30%≦D, more favorably 40%≦D, and even more favorably 50%≦D. The technique disclosed herein can be favorably implemented in an aspect in which the duty ratio is, for example, 40% or higher and 60% or lower (typically, 50% or higher and 60% or lower).

The pulse charging process in the charging method disclosed herein is favorably executed while cooling the nickel-hydrogen battery that is a processing object using a cooling mechanism. The cooling mechanism is not particularly limited as long as the nickel-hydrogen battery can be brought into contact with a coolant (for example, air or cooling water) and cooled. For example, the cooling mechanism can be a fan which sends air toward the nickel-hydrogen battery. When a load of pulse charge raises battery temperature (for example, to higher than 60° C.) and causes energy loss, reactivation of nickel hydroxide may not proceed sufficiently. In such a case, a quiescent period in which charge is suspended during the pulse charging process must be provided and the pulse charge must be restarted after lowering the battery temperature (for example, to 60° C. or lower). In contrast, according to the configuration described above, by performing the pulse charging process while cooling the nickel-hydrogen battery using a cooling mechanism, a rise in the battery temperature can be suppressed. Therefore, there is no need to provide a quiescent period for lowering the battery temperature and a charge time can be reduced.

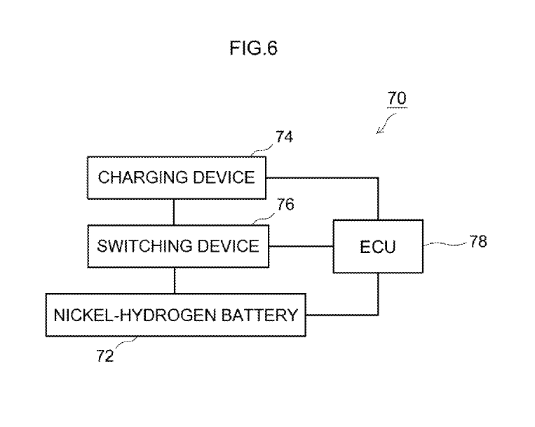

Next, a favorable example of a charging system capable of effectively implementing the charging method disclosed herein will be described with reference to FIG. 6. FIG. 6 is a diagram showing a schematic configuration of a charging system for a nickel-hydrogen battery.

As shown in FIG. 6, the charging system 70 for a nickel-hydrogen battery is constituted by a nickel-hydrogen battery 72 to be an object of a charging process, a charging device 74 which supplies a direct current to the nickel-hydrogen battery 72, a switching device 76 connected between the nickel-hydrogen battery 72 and the charging device 74, and a control device 78 respectively electrically connected to the nickel-hydrogen battery 72, the charging device 74 and the switching device 76.

The charging device (charging circuit) 74 is not particularly limited as long as a direct current can be supplied to a conventional nickel-hydrogen battery to charge the nickel-hydrogen battery and various device configurations can be adopted. For example, the charging device 74 can include a direct current power supply or a charger which is capable of charging the nickel-hydrogen battery 72 and which supplies a direct current. Alternatively, a regenerative mechanism configured to convert regenerative power created by a rotary electric machine (a motor generator) into a direct current and to supply the direct current to the nickel-hydrogen battery 72 may be used as a charging device for constructing the present system.

The switching device (switching circuit) 76 is not particularly limited as long as a direct current supplied from the charging device 74 to the nickel-hydrogen battery 72 can be converted into a pulse current and various device configurations can be adopted. For example, the switching device 76 can include a semiconductor element for electric power such as an insulated-gate bipolar transistor (IGBT), a gate turn-off thyristor (GTO), a static induction transistor (SIT), and a field-effect transistor (FET). The switching device 76 is configured to be capable of converting a direct current from the charging device 74 into a square-wave pulse current by switching (ON/OFF) the semiconductor element for electric power.

The control device 78 is configured to control the switching device 76 so that the direct current supplied to the nickel-hydrogen battery 72 from the charging device 74 is converted into a square-wave pulse current having a repetition frequency that is set within a range from 5 kHz to 10 kHz and having an average current value that is set within a range from 1 A to 10 A. The control device 78 may be any control device which can be configured in a general control system and, in the present embodiment, the control device 78 is an electronic control unit (ECU). The ECU 78 is configured as a device which controls operation of the nickel-hydrogen battery 72 connected to the charging device 74 via the switching device 76, and drives and controls the charging device 74 and the switching device 76 based on prescribed information. A typical configuration of the ECU 78 at least includes a read only memory (ROM) which stores a program for performing the control, a central processing unit (CPU) capable of executing the program, a random access memory (RAM) which temporarily stores data, and input/output ports (not shown). Various signals from a current sensor, a temperature sensor, a voltage sensor, and the like (all not shown) are input to the ECU 78 via the input port. In addition, various signals to the charging device 74 and the switching device 76 are output from the ECU 78 via the output port.

When actuating the charging system 70 described above, first, a signal announcing start of charge is transmitted from the ECU 78 and received by the charging device 74. A direct current is supplied from the charging device 74 having received the signal toward the nickel-hydrogen battery 72. In addition, a signal for performing a pulse current converting process is transmitted from the ECU 78 and received by the switching device 76. By switching ON/OFF a semiconductor element for electric power (for example, an IGBT), the switching device 76 having received the signal converts the direct current supplied to the nickel-hydrogen battery 72 from the charging device 74 into a square-wave pulse current having a repetition frequency that is set within a range from 5 kHz to 10 kHz and having an average current value that is set within a range from 1 A to 10 A. In this manner, a pulse current with a specific waveform is supplied to the nickel-hydrogen battery 72 and the nickel-hydrogen battery 72 is charged.

According to the charging system 70 described above, with a simple configuration of incorporating the switching device 76 between the nickel-hydrogen battery 72 and the charging device 74, it is possible to appropriately supply a square-wave pulse current having a repetition frequency that is set within a range from 5 kHz to 10 kHz and having an average current value that is set within a range from 1 A to 10 A. As a result, the existing charging device (charging circuit) 74 can be used and the cost required by the pulse charging process can be reduced since there is no need to make a design change to the charging device or use a plurality of power supplies. Therefore, the charging system 70 can be preferably adopted as a system for implementing the charging method described earlier.

While a test example relating to the present invention will be described below, it is to be understood that the present invention is not intended to be limited by the contents indicated in the following test example.

### <Construction of Nickel-hydrogen Battery>

A nickel-hydrogen battery (test cell) configured such that positive and negative electrodes, in which a positive electrode active material layer and a negative electrode active material layer are respectively retained by a positive electrode current collector and a negative electrode current collector, are laminated via a separator and housed in a case with an electrolyte was constructed.

A paste for forming the positive electrode active material layer was prepared by mixing nickel hydroxide powder as the positive electrode active material and other components of the positive electrode active material layer in a solution. The paste for forming the positive electrode active material layer was applied on the positive electrode current collector and dried to fabricate a positive electrode in which the positive electrode active material layer is provided on the positive electrode current collector.

A paste for the negative electrode active material layer was prepared by mixing a hydrogen storage alloy as the negative electrode active material and other components of the negative electrode active material layer in a solution. The paste for the negative electrode active material layer was applied on the negative electrode current collector (a nickel foil was used) and dried to fabricate a negative electrode in which the negative electrode active material layer is provided on the negative electrode current collector.

The fabricated positive electrode and negative electrode were laminated via a separator, the obtained laminate was housed in a case together with an electrolyte, and an opening of the case was air-tightly sealed. A sulfonated nonwoven polypropylene fabric was used as the separator. A potassium hydroxide water-based solution was used as the electrolyte. The nickel-hydrogen battery was assembled in this manner. Subsequently, an initial charging and discharging process (conditioning) was performed according to a conventional method to obtain a test cell.

### <Measurement of Initial Capacity>

After charging the test cell constructed as described above at a constant current with a current value of 3.0 A up to an SOC of 100%, the test cell was discharged at a constant current with a current value of 2.6 A down to a discharge lower limit voltage of 6.0 V, and a discharge capacity measured during the discharge was adopted as an initial capacity (rated capacity).

### <Cycle Degradation Test>

After the measurement of the initial capacity, a cycle degradation test was performed on the test cell. In the cycle degradation test, a charge-discharge cycle in which the test cell was first charged up to an SOC of 80% with a current value (direct current) of 2 A while maintaining battery temperature at 60° C. or lower and subsequently discharged to SOC of 20% with a current value (direct current) of 2 A was repeated seven or eight times every day continuously for two months. In addition, discharge amounts during discharge (discharge amounts at SOC of 20% to 80%) were measured in each cycle.

### <Pulse Charge Test>

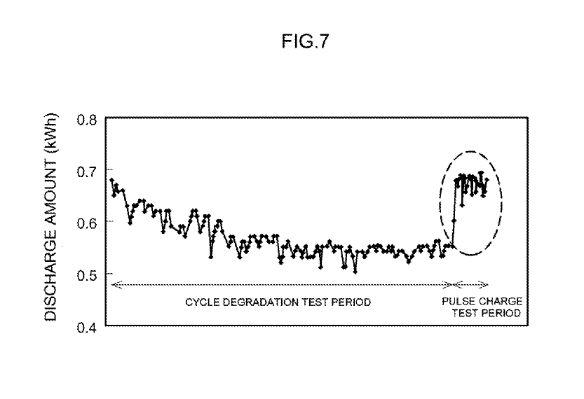

A pulse charging process was performed on the cell after the cycle degradation test described above. Specifically, a charge-discharge cycle of discharging the cell with a current value (direct current) of 2 A until the SOC dropped to 20% while maintaining battery temperature at 60° C. or lower and subsequently supplying a square-wave pulse current having a repetition frequency set to 10 kHz, an average current value set to 2 A, and a duty ratio set to 50% to charge the cell until the SOC reached 80% was repeated 24 times. In addition, discharge amounts during discharge (discharge amounts at SOC of 20% to 80%) were measured in each cycle. Results thereof are shown in FIG. 7. FIG. 7 is a graph showing a transition of the discharge amount described above of a battery subjected to a cycle degradation test and a pulse charge test.

As shown in FIG. 7, in the cycle degradation test in which charge and discharge are performed with a current value (direct current) of 2 A, the discharge amount shows a downward trend as charge and discharge are repeated. In contrast, in the period of the pulse charge test in which charge is performed by supplying a pulse current having a repetition frequency of 10 kHz and an average current value of 2 A, a degraded discharge amount shows a recovering trend and is subsequently maintained at a high level. From these results, it was confirmed that a decline in discharge capacity can be suppressed by performing charge using a pulse current with the specific waveform described above.

While a specific example of the present invention has been described in detail, the specific example is merely illustrative and is not intended to limit the scope of claims. Techniques described in the scope of claims include various modifications and changes made to the specific examples illustrated above.

What is claimed is:

1. A charging method for a nickel-hydrogen battery provided with a positive electrode at least including nickel hydroxide, the charging method comprising:
charging the nickel-hydrogen battery by supplying only a square-wave pulse current having a repetition frequency that is set within a range from 5 kHz to 10 kHz and having an average current value that is set within a range from 1 A to 10 A.

2. A charging system for charging a nickel-hydrogen battery provided with a positive electrode at least including nickel hydroxide, the charging system comprising:
a charging device which supplies a direct current to the nickel-hydrogen battery;
a switching device which is connected between the nickel-hydrogen battery and the charging device; and
a control device which controls the switching device so that the direct current supplied to the nickel-hydrogen battery from the charging device is converted into a square-wave pulse current having a repetition frequency that is set within a range from 5 kHz to 10 kHz and having an average current value that is set within a range from 1 A to 10 A.
